(19) United States
(12) Patent Application Publication
(10) Pub. No.: US 2004/0019854 A1
(43) Pub. Date: Jan. 29, 2004

(54) Dynamically configurable page numbering system

(76) Inventors: Truc Nguyen, San Diego, CA (US); Katie Kuwata, Oceanside, CA (US); William Su, Corona, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/205,307

(22) Filed: Jul. 24, 2002

(51) Int. Cl. G06F 15/00

(52) U.S. Cl. 715/525

(57) ABSTRACT

A method for dynamically configuring page number information for a document. An object file is created that stores page number, attribute and media type information for the document. When the document is processed, the document is merged with the object file, producing an output comprising the document with the page number data from the object file. The page number data is structure in at least one self-organized object. Preferably the object file is an XML file. A user interface comprised of independent modules written in XML provides the functionality to add, edit and/or delete the page number data.

### BACKGROUND OF THE INVENTION

The present invention is generally related to image generating systems and more particularly to a dynamically configurable page numbering system for an image output system.

Earlier systems for page numbering comprised superimposing bit maps on the document image. Referring to FIG. 1, there is shown how earlier systems generate an image. A document 10, is overlaid with a bitmap file 12 containing the page number 14. As shown in FIG. 1 the bitmap file contains an outline of the page, however as those skilled in the art can readily appreciate, the bitmap file may cover the entire page area of the document 10. After the document 10, is overlaid with a bitmap file 12, an image 16 is produced that comprises the document 10 with the page number 14.

In order to delete a page number in the earlier systems, the system would white out the border around the document to remove the page number. Modifying a page number would require first deleting the original page number, and superimposing another bit map on the document image. Because the earlier systems stored the page numbers as bit maps to be superimposed on the document, page number attributes and properties of the media, or any other useful information could not be stored.

Thus, there exists a need for a dynamically configurable page numbering system that allows a user to generate and modify page number information that can be managed through a number of processes, including but not limited to editing, inserting, deleting, copying, etc.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of instrumentalities and combinations particularly pointed out in the appended claims.

### BRIEF SUMMARY OF THE INVENTION

In view of the aforementioned needs, the invention contemplates a method and system for dynamically configuring page numbers. The method comprising the steps of storing a document, storing page numbering data for the document in an object file, and processing the document, wherein the document is merged with the object file, producing an output, the output comprising the document with the page number data from the object file. Preferably, the page number are structured in at least one self-organized object, and the object file is an XML file. By using XML, page number attributes and properties of the media data may also be stored. Furthermore, a user interface providing the functionality to edit and delete the page number information, preferably comprised of independent modules written in XML enable a user to quickly and easily modify the page number data.

The present invention also contemplates a computer-readable medium of instructions, comprising means suitably adapted to storing a document, means suitably adapted to storing page numbering data for the document in an object file; and means suitably adapted to processing the document, wherein the document is merged with the object file. When the document is merged with the object file, an output is produced. The output comprising the document with the page number data from the object file.

The present invention further contemplates computer readable instructions stored on a computer readable medium thereon, the computer readable instructions comprising instructions for creating a document, instructions for storing page numbering data for the document in an object file, and instructions for processing the document, wherein the document is merged with the object file. When the document is merged with the object file an output is produced. The output comprising the document with the page number data from the object file.

In addition, the present invention contemplates an image processing apparatus for producing an image comprising a first memory for storing a document, a second memory for storing page numbering data for the document in an object file, and a processor for processing the document wherein the document is merged with the object file. When the document is merged with the object file an output is produced, the output comprising the document with the page number data from the object file.

Among those benefits and improvements that have been disclosed, other objects and advantages of this invention will become apparent from the following description taken in s conjunction with the accompanying drawings. The drawings constitute a part of this specification and include exemplary embodiments of the present invention and illustrate various objects and features thereof.

### BRIEF DESCRIPTION OF THE SEVERAL VIEWS OF THE DRAWING

The drawings illustrate the best mode presently contemplated of carrying out the invention.

This the drawings:

FIG. 1 is a block diagram illustrating the method of adding page numbers to a document in the prior art;

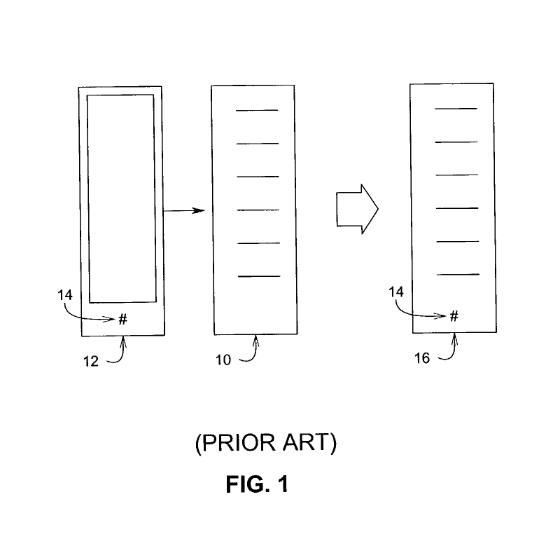

FIG. 2 is a block diagram illustrating the method of the present invention;

FIG. 3 is an example of a User Interface for use with the present invention.

### DETAILED DESCRIPTION OF INVENTION

Throughout this description, the preferred embodiment and examples shown should be considered as exemplars, rather than limitations, of the present invention.

The present invention provides a dynamically configurable page numbering system in which page numbers are treated as objects stored in XML files. The XML files store data representative of the page number, related attributes, and properties of the media on which the page number is to be printed. The present invention uses an object oriented architecture to process page numbers. The page number information is structured as one or more self-organized objects. The present invention also contemplates providing a user interface that allows a user to generate page number information that can be easily managed and provides functionality to insert, delete, copy, and edit page number information. All the process provided by the user interface are similar to the way in which text is handled in a standard word processor application.

The object oriented nature of this invention provides independent program modules written in an XML format that work together as a group at runtime without any prior linking or pre-compilation. Thus, the objects interoperate at runtime strictly through messages passed between them.

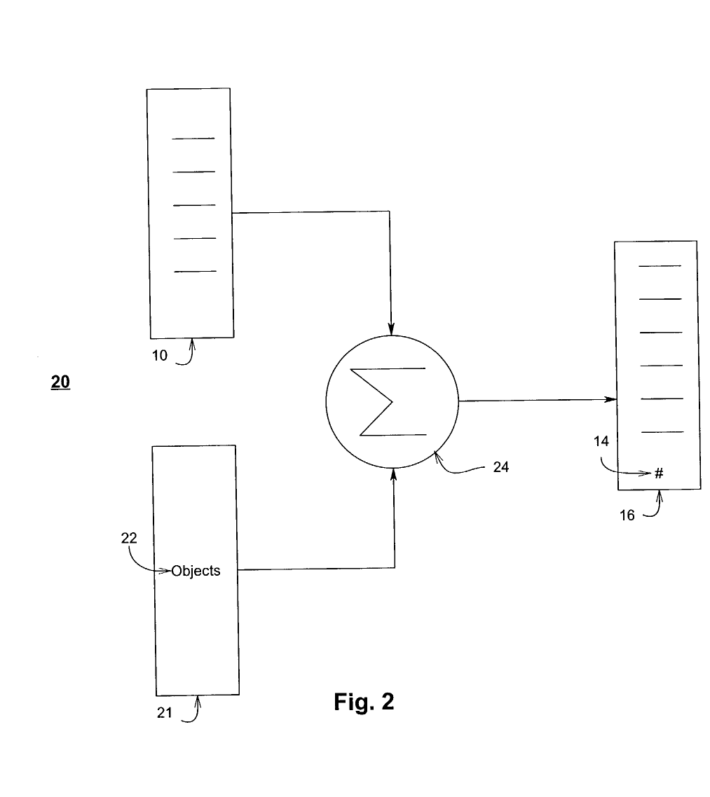

Referring now to FIG. 2 there is shown a block diagram 20 describing the interaction the various features of the present invention. A processor 24 acts as a summer to merge the document 10 with objects 22 stored in an object file 21. Typically, the object file 21 is an XML file and the objects 22 stored in the object file 21 are XML objects. After processing the document 10 and the object file 21, the processor 24 produces an output 16. The output comprising the document 10 and a page number 16 which is generated by processing the objects 22 stored in the object file 21.

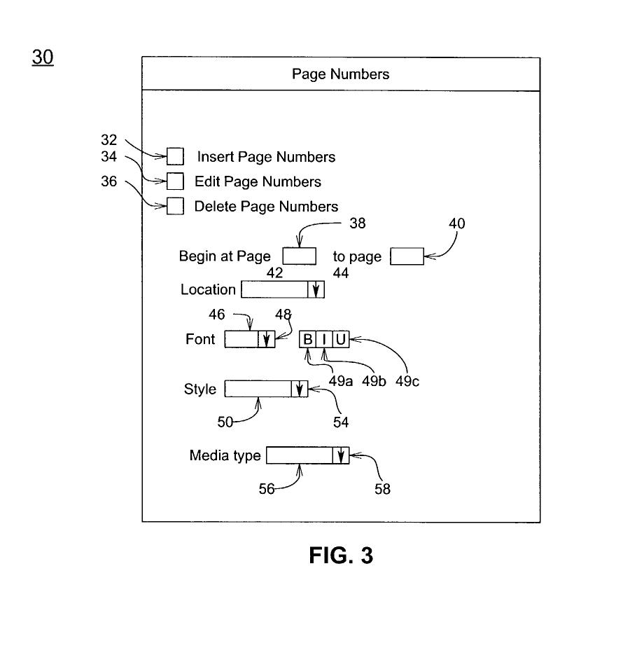

Referring now to FIG. 3, there is shown an example of a user interface 30. By selecting checkboxes 32, 34 or 36 a user can either insert page numbers, edit page numbers, or delete page numbers respectively. At box38 the user would enter the page number of the document to start at and at box 40 the page number to stop at. The location box 42 enables the user to specify the location on the page where the page number should be printed. A pre-selected list of locations can be accessed by selecting the arrow 44 next to the box 42. Box 46 enables the user to select the font for the page number. Arrow 48 can be used to allow the user to select a font from a pre-selected list. Pushbuttons 49a, 49b and 49c enable the user to make the page numbers bold, italicized, or underlined respectively. Style box 50 enables the user to select various styles of page numbers, for example page 1 or 20, or the user can specify that the page numbers appear as Roman Numerals, Arabic Numbers, or other styles. Arrow 54 enables the user to select a style from a pre-selected list. Finally, the Media type can be entered in box 56 or arrow 58 can be used to select from pre-selected sizes such as Letter, A3, A4, etc. As FIG. 3 is an example of the preferred embodiment, the arrangement of the fields and the naming of the fields as limiting as those skilled in the art can readily appreciate that there are an many alternatives available.

After the user enters the data into the user interface 30, the data is stored as objects 22 in the object file 21. What follows is an example of the objects 22 being stored in the object file as XML code:

<key name=“Page Number”>

<value name=“number” type=“uint32”>2</value>

<value name=“display as page number” type=“uint32”>1,</value>

<value name=“font” type=“string”>Arial,10 point,Bold</value>

<value name=“position” type=“string”>bottom,center</value>

<value name=“style” type=“string”>Arabic</value>

<value name=“media attributes” type=“string”>letter</value>

</key>

Thus, at runtime when the processor 24 of an image forming apparatus (not shown) processes the document 10, the processor simultaneously processes the objects 22 in the object file 21. As shown in the above example, when the processor 24 prints page 2 of the document, it will display page number “1” in arabic numerals, using an Arial 10 point bold font, at the bottom center of the page, the page being letter sized.

Although the invention has been shown and described with respect to a certain preferred embodiment, it is obvious that equivalent alterations and modifications will occur to others skilled in the art upon the reading and understanding of this specification. The present invention includes all such equivalent alterations and modifications and is limited only by the scope of the following claims.

What is claimed is:

1. A method for dynamically configuring page numbers, the steps comprising:
storing a document;
storing page numbering data for the document in an object file; and
processing the document, wherein the document is merged with the object file;
wherein an output is produced, the output comprising the document with the page number data from the object file.

2. The method of claim 1 wherein the page number data is structured in at least one self-organized object.

3. The method of claim 1 wherein the object file is an XML file.

4. The method of claim 3, the XML file further comprising page number attribute and properties of media data.

5. The method of claim 1 further comprising providing a user interface that allows a user to generate page number information.

6. The method of claim 5 wherein the user interface provides functionality to edit and delete the page number information.

7. The method of claim 6 wherein the user interface comprises independent modules written in XML.

8. A computer-readable medium of instructions, comprising:
means suitably adapted to storing a document;
means suitably adapted to storing page numbering data for the document in an object file; and
means suitably adapted to processing the document, wherein the document is merged with the object file;
wherein an output is produced, the output comprising the document with the page number data from the object file.

9. The computer readable medium of claim 8 wherein the page number data is structured in at least one self-organized object.

10. The computer readable medium of claim 8 wherein the object file is an XML file.

11. The computer readable medium of claim 10, the XML file further comprising page number attribute and properties of media data.

12. The computer readable medium of claim 8 further comprising providing a user interface that allows a user to generate page number information.

13. The computer readable medium of claim 12 wherein the user interface provides functionality to edit and delete the page number information.

14. The computer readable medium of claim 13 wherein the user interface comprises independent modules written in XML.

15. Computer readable instructions stored on a computer readable medium thereon, the computer readable instructions comprising:
instructions for creating a document;
instructions for storing page numbering data for the document in an object file; and
instructions for processing the document, wherein the document is merged with the object file;
wherein an output is produced, the output comprising the document with the page number data from the object file.

16. The computer readable instructions of claim 15 wherein the page number data is structured in at least one self-organized object.

17. The computer readable instructions of claim 15 wherein the object file is an XML file.

18. The computer readable instructions of claim 17, the XML file further comprising page number attribute and properties of media data.

19. The computer readable instructions of claim 15 further comprising instructions for providing a user interface that allows a user to generate page number information.

20. The computer readable instructions of claim 19 wherein the instructions for providing a user interface further comprises instructions for functionality to edit and delete the page number information.

21. The computer readable instructions of claim 20 wherein the user interface comprises independent modules written in XML.

22. An image processing apparatus for producing an image comprising:
a first memory for storing a document;
a second memory for storing page numbering data for the document in an object file; and
a processor for processing the document, wherein the document is merged with the object file;
wherein an output is produced, the output comprising the document with the page number data from the object file.

23. The apparatus of claim 22 wherein the page number data is structured in at least one self-organized object.

24. The apparatus of claim 23 wherein the object file is an XML file.

25. The apparatus of claim 24, the XML file further comprising page number attribute and properties of media data.
